(19) United States
(12) Patent Application Publication
(10) Pub. No.: US 2015/0161103 A1
(43) Pub. Date: Jun. 11, 2015

(54) METHOD ALLOWING THE FUSION OF SEMANTIC BELIEFS

(71) Applicants: Amandine Bellenger, Aviron (FR); Sylvain Gatepaille, Louviers (FR); Habib Abdulrab, Mont Saint Aignan (FR)

(72) Inventors: Amandine Bellenger, Aviron (FR); Sylvain Gatepaille, Louviers (FR); Habib Abdulrab, Mont Saint Aignan (FR)

(73) Assignee: AIRBUS DS SAS, Elancourt (FR)

(21) Appl. No.: 14/391,594

(22) PCT Filed: Apr. 10, 2012
(86) PCT No.: PCT/FR2012/000140

§ 371 Date: Jan. 9, 2015

(51) Int. Cl. G06F 17/27

(52) U.S. Cl. CPC G06F 17/2785

(57) ABSTRACT

A method capable of providing a control unit with a previously unknown capability of reasoning on this knowledge. A non-exhaustive list of particularly interesting technical applications can be derived from such a method particularly in the military and civilian fields, for example such as the identification of entities by a humanoid robot, or identification of entities for peacekeeping or first aid missions, or detection of potential obstacles during displacement of an automobile vehicle, or identification of unknown ships, or identification of potential targets for drones, aircraft, land vehicles such as extraterrestrial vehicles or warships.

### FIELD OF THE INVENTION

This invention relates to the field of semantic Web technology and its applications in merging information. It is more particularly applicable to a method for merging semantic beliefs. A non-exhaustive list of particularly interesting technical applications can be derived from such a method particularly in military and civilian fields, for example such as the identification of entities by humanoid robot, or identification of entities for peacekeeping or first aid missions, or detection of potential obstacles during displacement of an automobile vehicle, or identification of unknown ships, or identification of potential targets for drones, aircraft, land vehicles such as extraterrestrial or warships.

### STATE OF THE ART AND TECHNICAL PROBLEMS ENCOUNTERED

In the state of the art, the semantic Web technology provides a means for machines to understand semantics, in other words the meaning of information on the Web. Semantic Web technologies are used more and more frequently for all types of applications, for example extending from the medical field to information merging applications. Semantic technologies provide powerful means for representing knowledge, but they also help to improve reasoning capabilities.

Ontology includes concepts used to describe and represent a knowledge field. By clearly and semantically defining a group of terms in a given domain and unambiguously identifying relations between these terms, it becomes possible for an ontological system to encode knowledge about the domain, such that this knowledge can be understood by any software agent.

Information merging applications provide a means of combining data and information collected from different sensors. In this case, the term sensor should be understood in the broad sense. It includes physical devices for data acquisition, for example such as a camera, radar or information from the Web. Therefore, in this case a sensor is seen as a source of information.

These information merging applications enable a better understanding of a given situation and make it possible to estimate or predict its future change. In this context, ontological systems or knowledge representations are useful by supplying means for description and reasoning about sensors data, objects, relations and general theories related to the domain. In this way, ontological systems can be used to explicitly encode shared understanding of a given domain and to make terms associated with this domain less ambiguous.

However, all these application fields need to take account of the uncertainty that may be contained in the knowledge that it wants to represent and use. In the field of information merging, uncertainty is one of the most important characteristics of collected information and as such, it has to be taken into account in the information combination process that will combine the information.

Although those skilled in the art consider that the semantic Web technology was designed to capture a minimum uncertainty present in knowledge, this technology does not enable reasoning about quantification of the uncertainty. The question of processing the uncertainty is always considered as a major defect in these technologies.

The term uncertainty firstly covers a variety of forms of imperfect knowledge such as imprecision, the random aspect, inconsistency and ambiguity. Throughout the remainder of this description and to make it easier for everyone to understand, we will consider the term uncertainty to refer only to incomplete or imprecise information, particularly due to lack of knowledge or to inconsistency of information, principally due to reports from different sensors that can result in contradictory information.

Many research workers have attempted to improve the capabilities of ontological systems to overcome weaknesses related to uncertainty in knowledge representation.

In earlier and classical merging applications, research workers at the Cassidian S.A.S Company, a division of the E.A.D.S group, used the theory of evidence to combine uncertain data. This theory of evidence is also called the Dempster-Shafer theory or also the belief functions theory. Ontological systems have been used more recently in the field of semantic information merging applications, but the use of uncertainty theories as mentioned above in this new environment do not give conclusive results.

Therefore there is a need for those skilled in the art to overcome uncertainties in representing knowledge or information.

### PRESENTATION OF THE INVENTION

This invention aims at solving all disadvantages that arise in the state of the art. To achieve this, the invention discloses the method of merging semantic beliefs.

Concerning theories related to uncertainty, our research workers have decided to consider the intrinsic meaning of hypotheses in an automated manner in order to add a semantic dimension to uncertainty theories. These uncertainty theories are conventionally based solely on the label of hypotheses. Thus, the fact that the intrinsic sense of hypotheses is taken into account enables a system to reason, which includes combination and decision-making aid steps, on these said hypotheses that were modelled through an ontological system, and to which degrees of belief have been previously assigned. Consequently, information sources do not need to be concerned with the level of granularity of hypotheses to which they attribute degrees of belief, because these hypotheses do not need to be exclusive to each other at the input to the process. Exclusive hypotheses mean that each hypothesis is distinct and strictly separated from the other hypotheses.

Consequently, the fact of considering the intrinsic meaning of hypotheses related to the uncertainty of information provides a means of automatically solving a number of problems, such as semantic translation of hypotheses.

For example, consider the case of two information sources indicating their belief state about a specific phenomenon. In such a case, let us imagine that one of these two sources indicates that this specific phenomenon may be or is a land vehicle or an aircraft with an associated belief value for each hypothesis, and that the other source indicates that this specific phenomenon may be a car or a truck, with an associated belief value for each hypothesis. Therefore in this example, it appears that labels of the different hypotheses are all different. However, the sense of each of these hypotheses is not completely disjoint from the others. The belief that this specific phenomenon may be a land vehicle is in no way contradictory with the fact that it may be a car or a truck. Then, with an appropriate model of the domain in which we are interested, with the system according to the invention we can say that the two sources are not in total conflict and that we can apply a method according to the invention for combination and decision-making aid.

In another example, we have one of the sources that indicates that this specific phenomenon may be a fire engine or a police car with an associated belief value, and another of these sources states that this specific phenomenon might be a red truck or a police car. We will assume that the ontological system defines the concept of “fire engine” as in this example being in the “truck” class with the property in particular that its colour is “red”. In this example, it is clear that the labels of hypotheses would enable us to apply a combination and decision-making process but would lead to false results because they would not have taken account of the fact that the red truck instance is not contradictory to the fire engine instance. However, the method according to the invention is capable of reformulating this discernment framework taking account of the semantics of hypotheses so that an appropriate combination and decision-making aid process can be adopted.

This framework reformulation process is well known because a human brain does it intuitively. But the advantage of the invention is very significant in this case because it allows said process to be completely automated by a computer or a control unit. This global automation of the information combination and decision-making aid process is particularly appreciable in highly dynamic and automated environments in which human reasoning is impossible due to the quantity of information to be processed and/or the allowed time.

Consequently, all application domains making use of ontology systems can benefit from the method according to the invention, including the semantic Web, merging of information and any other semantic applications that need to process with uncertain knowledge.

Therefore, the purpose of the invention is a method for merging semantic beliefs comprising the following steps:
information related to a single phenomenon and originating from different sources is received,
the received information is stored in a database called the knowledge base, in the form of instances of a given ontology,
depending on the initial information sources or depending on the processing of this information, degrees of belief are associated with instances describing this phenomenon, thus defining candidate instances for the description of this phenomenon,

characterised in that,
semantic inclusions between all candidate instances of a single phenomenon are determined,
semantic similarities between all candidate instances of a single phenomenon are calculated,
a threshold on these semantic similarities is calculated beyond which it is considered that the semantic similarities represent semantic intersections,
depending on the semantic inclusions and intersections, all the candidate instances of this phenomenon are transposed into a discernment framework of the evidence theory, in other words a set in which the elements of this framework are exclusive,
the degrees of belief are reassigned in this discernment framework such that the degree of belief associated with a candidate instance is equal to the degree of belief of the union of its elements transposed in the discernment framework,
if several information sources assigned degrees of belief, they are combined at the level of the discernment framework, and
decision-making criteria of the evidence theory are applied in order to determine which group of elements in the discernment framework corresponds to the best hypothesis, among the groups of elements transposed from a candidate instance,
the initial candidate instances are returned with their associated combined degree of belief and decision-making aid indicating the best candidate instance.

Another purpose of the invention is a system capable of implementing the method for merging semantic beliefs according to the previous characteristics.

### DESCRIPTION OF THE INVENTION

The following embodiments are examples. Although the description refers to one or several embodiments, this does not necessarily mean that each reference concerns the same embodiment, or that the characteristics are only applicable to a single embodiment. Simple characteristics of different embodiments may also be combined to form other embodiments.

Therefore, the purpose of the invention is a method for semantic merging of beliefs. This method provides a control unit with a previously unknown capability of reasoning on this knowledge. Such a control unit is known to those skilled in the art, and is not covered by this invention. Therefore, there is no point in giving any further description of this control unit. However, actions carried out by the control unit of the system using the method according to the invention, are scheduled by at least one microprocessor. This microprocessor produces orders in response to instruction codes recorded in a program memory, in order to implement the method according to the invention and the different devices (sensors, means, etc.) associated with said control unit.

For example, an instance is a fact in the domain of interest that may either be a class instance or a property instance. An instance can then be seen as anything that is not a concept. Concepts are ontology classes and properties that describe the terminology of the domain of interest.

The different sources of information consisting of sensors populate the same ontology as the process continues, depending on their state of belief. In other words, they create instances of the ontology as the process continues. Ontology means a collection of classes and relations between these classes. These classes and relations are organised according to a hierarchical structure. These classes are concepts, for example such as “Human”, “Woman”, “Man”, “Child”, etc.

Thus, when the control unit's sensors detect the same uncertain phenomenon, the control unit collects the phenomenon in its databases, such that repetition of this phenomenon will provide the control unit with more clarification and more precision of the description of said phenomenon.

Uncertainty is represented by instantiation of ontology systems of the domain, in which the uncertain candidate instances with their associated degree of belief, and the source that indicated its stage of belief, are defined. Uncertain instances may be either uncertain instances of classes or uncertain instances of properties of an ontology.

According to the invention, concepts of Boolean semantic operators such as semantic inclusion and intersection between ontological instances are introduced. Therefore, two semantic operators are defined, namely “SemanticInclusion” and “SemanticIntersection”. Each of these two operators receives a set of instances as input.

With the SemanticInclusion operator, the control unit can determine semantic inclusion between instances. Consider two instances “Ij” and “Ik”, it is noted that Ij is semantically included in Ik by Ij⊂ₛₑₘIk. If Ij and Ik are property instances, then Ij is semantically included in Ik if Ij is a sub-property of Ik. If Ij and Ik are class instances, then Ij is semantically included in Ik if all classes of Ik are superclasses of classes of Ij and all Ik relations are also Ij relations. Relation between instances means all properties of data types and all properties of objects, with their corresponding value and object.

The semantic intersection between Ij and Ik is denoted Ij∩nₛₑₘ Ik≠Ø. The algorithm that has been produced to define the SemanticIntersection operator is given below:

| | |
|---|---|
| 1 | program SemanticIntersection |
| 2 | input |

| | |
|---|---|
| 3 | Psi: Universal Set of Candidate Instances |

| | |
|---|---|
| 4 | output |

| | |
|---|---|
| 5 | hasIntersection[ ][ ]: Matrix of Boolean initialized as all false |

| | |
|---|---|
| 6 | var |

| | |
|---|---|
| 7 | Ij, Ik: candidate instance variables |
| 8 | simValue[ ][ ]: Matrix of Reals |
| 9 | threshold: Real |
| 10 | begin |
| 11 | forEach Ij in Psi |

| | |
|---|---|
| 12 | forEach Ik in Psi |

| | |
|---|---|
| 13 | if j = k |

| | |
|---|---|
| 14 | simValue[j][k] := 1; |

| | |
|---|---|
| 15 | else if j > k |

| | |
|---|---|
| 16 | simValue[j][k] := simValue[k][j] ; |

| | |
|---|---|
| 17 | else |

| | |
|---|---|
| 18 | simValue[j][k] := Similarity(Ij, Ik); |

| | |
|---|---|
| 19 | threshold := calculateThreshold(simValue[ ][ ]); |
| 20 | forEach Ij in Psi |

| | |
|---|---|
| 22 | forEach Ik in Psi |

| | |
|---|---|
| 23 | if(simValue[j][k] > threshold) |

| | |
|---|---|
| 23 | hasIntersection[j][k] := true; |

| | |
|---|---|
| 24 | end |

The lines in the above algorithm are numbered from 1 to 24 to facilitate positioning. Thus, lines 11 to 18 are dedicated to a step to calculate semantic similarity. Semantic similarity evaluates the proximity between instances of the same ontology. It is defined as a symmetric function that returns a value between 0 and 1. The closer this value is to 1, the more the concepts or instances are similar. Semantic similarity measurement functions do exist in the state of the art, therefore one of them can be chosen or an aggregation between them can be chosen for the method according to the invention.

The control unit then calculates a threshold and subsequently determines the semantic intersection. In this case, this threshold is calculated automatically from the list of values of semantic similarities, see line 19 in the previous algorithm. After cross-similarities of the set of all candidate instances calculated by the control unit have been measured, the control unit fixes a threshold using a binarisation method. Consequently the threshold varies depending on the list of semantic similarities calculated by the control unit.

With this method, the granularity of all candidate instances can be adapted. It reflects our general impression that the concept of a saloon car is closer to the concept of an MPV than to the concept of an aircraft. However, the concept of a saloon car is closer to the concept of an aircraft than to the concept of a book. In the first case, the intersection is made by the “saloon car” and “MPV” pair, while in the second case the intersection is made by the “saloon car” and “aircraft” pair. Note that in both cases, the value of the semantic similarity between the saloon car and aircraft concepts is identical.

The evidence theory is used to combine uncertain semantic information and to apply a certain decision procedure, so as to choose the best possible hypothesis. This is an extension of the probabilities used to assign weights to sets of specific hypotheses.

A discernment framework is required to apply evidential combination and decision-making aid processes.

In the following, we will use “UP” to denote all our semantic hypotheses, in other words all our candidate instances.

We will use “a” to denote the discernment framework defined according to the evidence theory. This discernment framework Ω is defined as being exhaustive and all its hypotheses are defined as being exclusive.

ψ cannot be treated like a discernment framework Ω: the elements of ψ do not necessarily satisfy the exclusivity condition. Candidate instances are not necessarily disjoint from each other. For example, ontological instances are not all at the same granularity level and some instances may be semantically included or have a semantic intersection with other instances. The purpose is to reformulate ψ to obtain a discernment framework Ω compatible with the conditions of the evidence theory, based on the semantic operators presented above.

Consider a transposition (or mapping) function “fmap”, to transpose a candidate instance into one or several virtual atomic states “Hi” of the discernment framework in accordance with the evidence theory:

$${f}_{map} \text{:} Ψ \to Ω$$

$${f}_{map} ( {I}_{j} ) = \{ {H}_{j} \cdot {⋃}_{k \vert {I}_{j} {⋂}_{sem} {I}_{k} \neq 0 /} {H}_{j , k} \cdot {⋃}_{k \vert {I}_{q} {⊆}_{sem} {I}_{j} \cdot {I}_{q} \neq {I}_{j}} {f}_{map} ( {I}_{q} ) \} .$$

This fmap function is recursive and it is reiterated in the case of inclusive instances. Considering the transitive effect of the semantic inclusion, we can rewrite this function by chaining two transposition functions such as

ƒₘₐₚ=ƒ_{mapInel}·ƒ_{mapInter}

where:

ƒ_{mapInel}(Iⱼ)={∪_{q|I}_{_{q}}_{⊂}_{ₐₑₘ}_{I}_{ⱼ}ƒ_{mapInter}(I_{q})}

and:

ƒ_{mapInter}(Iⱼ)={Hⱼ·∪_{k|I}_{ⱼ}_{∩}_{_{scm}}_{I}_{ₖ}_{≠Ø}H_{j,k}}.

The lines in the following algorithm are numbered from 1 to 22 to facilitate positioning. Thus, lines 13 to 17 are dedicated to a step in which the control unit calculates a first transposition considering only the semantic intersection. The control unit then applies a second part of the transposition that considers the semantic inclusion as illustrated in lines 18 to 21.

| | |
|---|---|
| 1 | program EvidentialMapping |
| 2 | input |

| | |
|---|---|
| 3 | Psi: Universal Set of Candidate Instances |

| | |
|---|---|
| 4 | output |

| | |
|---|---|
| 5 | Omega: Evidential Frame of Discernment |
| 6 | Map[[candidate instance], [atomic hypothetical states]]: |
| | the mapping |

| | |
|---|---|
| 7 | var |

| | |
|---|---|
| 8 | Ij, Ik: candidate instance variables |
| 9 | Hj, Hjk: atomic hypothetical state variables |

| | |
|---|---|
| 10 | begin |

| | |
|---|---|
| 11 | hasInclusion[ ][ ] := run SemanticInclusion; |
| 12 | hasIntersection[ ][ ] := run SemanticIntersection; |
| 13 | forEach Ij in Psi |

| | |
|---|---|
| 14 | Map[Ij] := [Hj] |
| 15 | forEach Ik in Psi |
| 16 | if hasIntersection[Ij][Ik] = true |

| | |
|---|---|
| 17 | Map[Ij] := [Map[Ij], Hjk] |

| | |
|---|---|
| 18 | forEach Ij in Psi |

| | |
|---|---|
| 19 | forEach Ik in Psi |
| 20 | if hasInclusion[Ij][Ik] = true |

| | |
|---|---|
| 21 | Map[Ij] := [Map[Ij], Map[Ik]] |

| | |
|---|---|
| 22 | end |

The degree of belief initially attributed to each candidate instance is then reattributed to its transposed elements in the discernment framework.

Thus, using the above method, the formalism of the semantic belief is transposed to the classical evidential formalism, so that we can apply combination and decision-making aid processes specific to the evidence theory.

The invention has a specific application in the maritime field. Information and observations about a maritime situation are transmitted to the control unit by different heterogeneous sensors (satellite, radar, AIS, LRIT, human report, drone, etc.).

Naturally, these sensors may have defects depending on the context in which they are used such as the weather, brightness, etc., that can lead to uncertainty about observed and transmitted information. Furthermore, systems such as AIS transmit information about and from the ships themselves. Thus, if a ship does not want its genuine identity to be known for malicious reasons, the captain of the ship can send a false message. Consequently, AIS information is not always reliable.

All these situation observation messages are stored at the level of instantiation of a maritime domain ontology.

Therefore, the invention discloses an identification system using the method according to the invention for merging semantic beliefs.

This identification system is subdivided into several secondary subsystems corresponding to independent identification services. Each of these subsystems has its own specific features. For example, one subsystem uses the shape of the ship trajectory in order to deduce the identification of the ship type, another subsystem uses intrinsic attributes of the ship such as its type of design given by the AIS, its size, its colour, etc. Another subsystem also uses contextual information about the ship such as its geographic zone, etc., always for ship type identification reasons. These subsystems use semantic information originating from ontology.

Since information about a ship is uncertain, each identification subsystem deduces uncertain conclusions about the type of identification to be associated with the ship.

Their conclusions are ontology instances corresponding to hypotheses about the identification of the ship. More precisely, their conclusions are composed of a set of candidate instances with an associated degree of belief.

Each identification subsystem according to the invention is then considered to be an information source assigning belief values to the different deduced identification hypotheses.

The method is then applied to combine these semantic beliefs related to uncertain ship identification so as to provide a decision-making aid about ship identification that can be adopted.

1. Method for merging semantic beliefs comprising:
receiving information related to a single phenomenon and originating from different sources;
storing the received information in a knowledge database, in the form of instances of a given ontology,
depending on the initial information sources or depending on the processing of the information, associating degrees of belief with instances describing the phenomenon, thus defining candidate instances for the description of the phenomenon,
wherein,
semantic inclusions between all candidate instances of a single phenomenon are determined,
semantic similarities between all candidate instances of a single phenomenon are calculated,
a threshold on the semantic similarities is calculated beyond which it is considered that the semantic similarities represent semantic intersections,
depending on the semantic inclusions and intersections, all candidate instances of the phenomenon are transposed into a discernment framework of the evidence theory,
the degrees of belief are reassigned in the discernment framework such that the degree of belief assigned to a candidate instance is equal to the degree of belief of the union of its elements transposed in the discernment framework,
if several information sources have assigned degrees of belief, the sources are combined at the level of the discernment framework, and,
decision-making criteria of the evidence theory are applied in order to determine which group of elements in the discernment framework correspond to the best hypothesis, among the groups of elements transposed from a candidate instance,
the initial candidate instances are returned with their associated combined degree of belief and decision-making aid indicating the best candidate instance.

2. System capable of implementing the method for merging semantic beliefs according to claim 1.
